(19) United States
(12) Patent Application Publication
(10) Pub. No.: US 2008/0149563 A1
(43) Pub. Date: Jun. 26, 2008

(54) Method of controlling dialysis using blood circulation times

(75) Inventor: Stephen R. Ash, Lafayette, IN (US)

Correspondence Address: JONES DAY, 222 E.41ST STREET, NEW YORK, NY, 10017, US

(73) Assignee: Renal Solutions, Inc.

(21) Appl. No.: 11/644,237

(22) Filed: Dec. 22, 2006

(51) Int. Cl. B01D 61/32

(52) U.S. Cl. 210/646

(57) ABSTRACT

The instant method involves intermittently infusing saline boluses into a patient's bloodstream during dialysis, and monitoring how long it takes for the bolus to complete a full circuit through the body. The concentrations versus time of one of more return flows as a result of the injected bolus are measured including a peak resulting from a fast circuit path, a peak resulting from a slow circuit path, and an average of the two aforementioned peaks. These parameters can be monitored over time in response to the injection of a plurality of boluses and their values over time used to determine the condition of the patient. Because of the rules governing abstracts, this abstract should not be used to construe the claims.

### BACKGROUND

The present invention is related to dialysis machines and methods of operating such machines.

There are a number of steps to successful performance of hemodialysis, and a number of critical decisions must be made during each treatment. The need for clinical decisions makes the therapy considerably harder than other medical therapies, especially those performed at home. The best place for performing chronic dialysis is at the home, but the patients must be trained extensively to operate the machine, monitor their physical condition and make various decisions such as proper blood pump speed, amount and timing of anticoagulation, and proper fluid removal during the treatment (ultrafiltered volume). The treatment is sufficiently complex that few patients can successfully run dialysis machine at home. Only about 1% of hemodialysis therapy is performed at home. Further, the first treatments of patients with sudden (acute) renal failure are often done without any idea of how much fluid can and should be removed from the patient.

During dialysis water and salt is removed by ultrafiltration, or the convection of fluid across the membrane in response to pressure gradients across the membrane. All dialysis machines can control the ultrafiltration rate but the question is how much fluid should be removed during each treatment. The goal is to remove enough to allow the patient to achieve “dry weight,” the weight below which the blood pressure will fall and adverse symptoms will develop. As water and salt is removed from the patient, both the vascular volume and blood pressure will decrease slightly. The vascular volume is replenished by excess water and salt from the interstitial space (edema, or just excess fluid volume) and from within cells (to some degree). When there is no more excess tissue fluid to replenish the vascular space, then the vascular volume falls and low blood pressure and symptoms occur. Deciding upon a dry weight value and varying the dry weight value is done empirically and requires considerable skill, knowledge, and “trial and error” by the patient and staff, based on measures of blood pressure, persistence of edema (extra water and salt evidenced as swelling), estimates as to whether muscle and fat weight has increased, and symptoms before and after dialysis.

A product called the Transonic system already exists and is marketed for use during dialysis treatments. The monitors can be attached to the blood lines, saline injected, and measurements performed of access blood recirculation, access blood flow (as in a fistula or graft), and cardiac output. This gives reasonably accurate measurements, but using the machine during the therapy requires many extra steps and is not practical for many treatments, so cardiac output is not routinely measured during dialysis. Another monitor (Critline, by In-Line Diagnostics) can also determine blood volume indirectly by analyzing changes in hematocrit after fluid injection, and these changes in measured blood volume have been used to estimate dry weight of dialysis patients. However, control of proper ultrafiltration rate requires subjective analysis of the shape of the volume versus time, as shown in Lepot, et al. “Continuous Blood Volume Monitoring and Ultrafiltration Control,” [Lopot F, Nejedlý B, Sulková S, Hemodialysis International, Vol. 4, E-14 (2000). For patients who are markedly fluid overloaded, inspection of the CritLine curve can allow more fluid to be withdrawn, but there is a learning curve for each patient to make this interpretation [Lopot F, Kotyk P, Blaha J, Forejt J., Use of continuous blood volume monitoring to detect inadequately high dry weight. Int J Artif Organs. July1996; 19(7):411-4]. According to a committee of EDTNA, continuous blood volume measurement “ . . . can assist in setting target weight, but must be used together with traditional measures and experience.” [Lindley E. J. Merits and limitations of continuous blood volume monitoring during hemodialysis. Summary of the EDTNA/ERCA Journal Club discussion: Winter 2005.EDTNA ERCA J. April-June 2006; 32(2):108-16.]

The Fresenius 2008K machine has several optional modules that are designed to provide some physiologic information during dialysis procedures: blood volume (by a technique similar to Critline), recirculation (by step temperature change of dialysate) and graft/fistula blood flow (by step conductivity change of dialysate). However, the Fresenius 2008K machine does not provide a cardiac output measurement capability nor any automatic determination of dry weight.

### SUMMARY

The instant method involves intermittently infusing saline boluses into the patient's bloodstream during dialysis, and monitoring how long it takes for the bolus to complete a full circuit through the body. According to one embodiment, a saline bolus is infused into the patient's blood as the blood enters the dialyzer. The bolus moves forward through the dialyzer with the blood and past an ultrasonic sensor located at the blood outflow line. The ultrasonic sensor at the blood outflow line senses a concentration change when the bolus passes the sensor. The time at which this occurs is saved as the time of injection. The saline bolus then is pumped by the patient's heart through the body with the blood and eventually is sensed by another ultrasonic sensor at the blood inlet line indicating that the bolus has gone completely through the patient. There are two peaks of saline that come back to the inflow sensor after an injection of saline, representing blood passing through different parts of the body: 1) an early peak due to flow of blood through high flow organs like the kidney, heart, brain, gut and liver, and 2) a slightly slower peak after a slower pass of blood through a circuit containing low flow body parts such as the muscles, skin, and bones.

The concept of two compartments for blood circulation during dialysis is not new, having been proposed by Schneditz and Daugirdas [Schneditz, Daniel & Daugirdas, John T. Compartment Effects in Hemodialysis.Seminars in Dialysis 14 (4), 271-277 (2001)]. There is also sometimes a very early and separate peak due to “cardiopulmonary recirculation,” blood passing from the heart through arteries leading directly back to the lung, or blood passing through a graft or fistula (dialysis devices) directly from an artery to a vein. For the purposes of this discussion, this very early peak will be ignored. See Schneditz et al., Cardiopulmanary recirculation during hemodialysis, International Society of Nephrology, Technical Note, 1992; Schneditz, et al., A Regional Blood Circulation Alternative to In-series Two Compartment Urea Kinetic Modeling, ASAIO, J., July-September; 39(3):M573-7 (1993).

The two curves representing flow of saline through the body may be nearly superimposed and result in what appears to be a single peak with a difference in shape of the leading and trailing edges. The curves can be separated mathematically, or the net effect of the fast flow and flow circuit can be measured by the mean transit time, which is the time from injection of saline to the peak of the combined curve. The proportion of saline that goes through the fast flow circuit vs. the slow flow circuit of the body can be analyzed to provide an indication of the patient's overall volume status and when the patient is reaching dry weight. After a predetermined time, another bolus is infused, and the process is repeated. One or more of measurements can be taken and compared as follows.

In one embodiment, a difference between the time of injection and the time of the return of the first peak resulting from the fast flow circuit is determined for each injected bolus. If the difference (between the time of injection and the time of the first peak) from one bolus injection to the next is constant, the patient is considered stable; if the difference (between the time of injection and the time of the first peak) from one bolus injection to the next is decreasing, the patient is considered to be approaching that patient's dry weight.

In another embodiment, a difference between the time of injection and the time of the return of the second peak resulting from the slow flow circuit is determined for each injected bolus. If the difference (between the time of injection and the time of the second peak) from one bolus injection to the next is constant, the patient is considered stable; if the difference (between the time of injection and the time of the second peak) from one bolus injection to the next is increasing, the patient is considered to be approaching that patient's dry weight.

In another embodiment, a difference between the time of injection and the time of the return of an average peak resulting from both the fast flow circuit and the slow flow circuit is determined for each injected bolus. If the difference (between the time of injection and the time of the average peak) from one bolus injection to the next is constant, the patient is considered stable; if the difference (between the time of injection and the time of the average peak) from one bolus injection to the next is decreasing, the patient is considered to be approaching that patient's dry weight.

In another embodiment, a difference between the time of the return of the first peak resulting from the fast flow circuit and a time of the return of the second peak resulting from the slow flow circuit is determined for each injected bolus. If the difference (between the time of the return of the first peak resulting from the fast flow circuit and the time of the return of the second peak resulting from the slow flow circuit) from one bolus injection to the next is constant, the patient is considered stable; if the difference (between the time of the return of the first peak resulting from the fast flow circuit and the time of the return of the second peak resulting from the slow flow circuit) from one bolus injection to the next is increasing, the patient is considered to be approaching that patient's dry weight.

It is envisioned that the method could be used with various types of extracorporeal blood therapies such as blood treatment for liver failure, sepsis, and viral infections. In other applications the method would determine if water needed to be removed or whether circulating volume needed to be expanded.

The saline used in these tests can be removed easily by automatically increasing the ultrafiltration rate of the dialysis machine. In fact, there are additional benefits of such saline administration in improving clearance of larger molecular weight toxins (“middle molecules”) by the increased ultrafiltration rate of dialysis machine and decreasing clotting tendency (decreasing or avoiding the need for heparin during the dialysis). Those, and other advantages and benefits, will become apparent from the description below.

### BRIEF DESCRIPTION OF THE FIGURES

For the present invention to be easily understood and readily practiced, the present invention will now be described, for purposes of illustration and not limitation, in conjunction with the following figures wherein:

FIG. 1 is a block diagram of a dialysis system according to the teachings of the present invention;

FIG. 2 illustrates a blood flow model through the human body [Schneditz, et al, “Cardiopulmonary recirculation curing hemodialysis,” supra];

FIG. 3A is a timing diagram illustrating the injection of a plurality of boluses into a patient during dialysis and FIGS. 3B and 3C are timing diagrams illustrating various measurements taken in response to the injected boluses according to certain embodiments of the present invention; and

FIG. 4 is a flow chart illustrating various embodiments of the process of the present invention.

### DESCRIPTION OF A PREFERRED EMBODIMENT

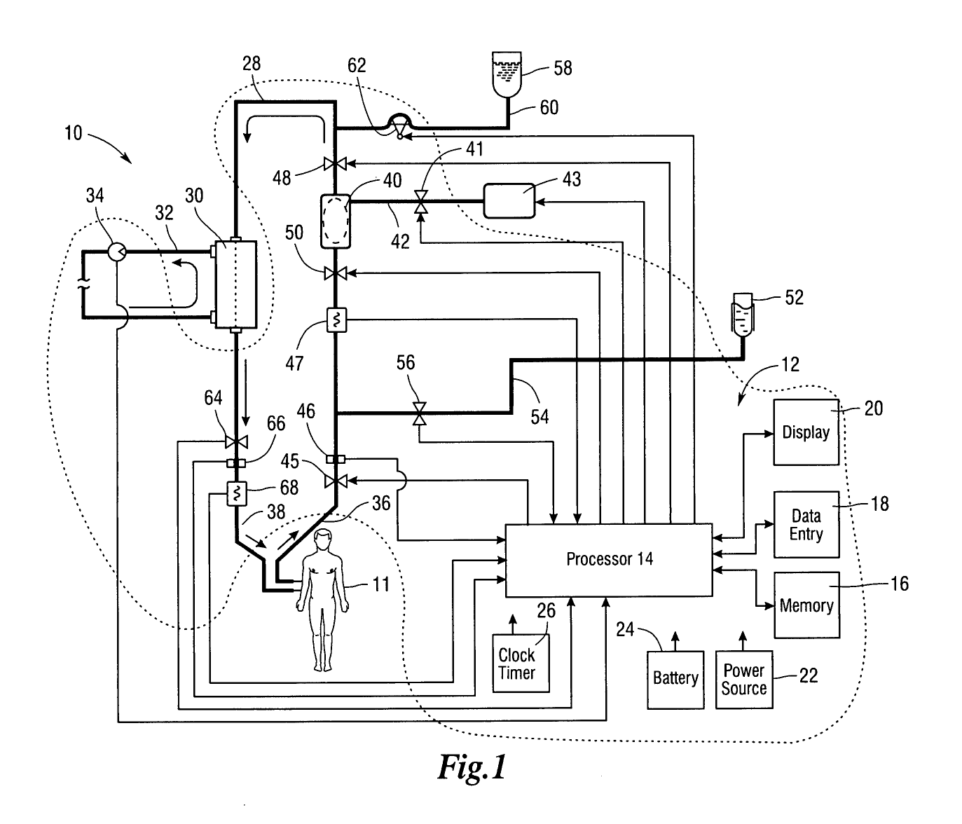

The dialysis system shown schematically in FIG. 1 has parts that are examples of the elements recited in the apparatus claims, and can be operated in steps that are examples of the elements recited in the method claims. The illustrated system thus includes examples of how a person of ordinary skill in the art can make and use the claimed invention. The system is described here to meet the enablement and best mode requirements of the patent statue without imposing limitations that are not recited in the claims.

FIG. 1 is a schematic of a dialysis system 10 with which the present invention can be used. Referring to FIG. 1, the system 10 is a renal dialysis system for the extracorporeal treatment of blood from a patient 11 whose kidney function is impaired. The illustrated embodiment of the dialysis system 10 comprises a dialysis machine 12 as is generally known in the medical arts, and shown generally within the dotted line, plus various consumables as is known in the art.

The dialysis machine 12 may be provided with a non-volatile memory component 16 adaptively coupled to an electronic control means 14, which may be a processor. Non-volatile memory component 16 can be any form of memory component that retains stored values when external power is turned off. For example, such non-volatile memory components can be selected from the group consisting of a hard disk, flash memory, battery-backed-up RAM, or other data storage device. The memory 16 may store instruction which, when executed, perform the various embodiments of the disclosed method.

Dialysis machine 12 further includes a data entry device 18, such as a keyboard, touch-screen monitor, computer mouse, or the like. Dialysis machine 12 further includes a display device 20, such as a read-out monitor, for displays of operating values of the various individual components of the dialysis machine 12. The system 10 can be provided with a power source 22, a battery back-up 24, and a clock/timer 26. The processor 14, memory 16, data entry device 18, and clock/timer 26 represent one configuration of a control system.

The dialysis system 10 comprises a blood circuit 28 through which the patient's blood travels, a dialyzer 30 that serves to separate the wastes from the blood, and a dialysate circuit 32 through which treatment fluid, specifically dialysate, travels carrying the waste away.

The dialysate circuit 32 includes a dialysate pump 34 for driving dialysate fluid through a tube set and through the dialyzer 30. The dialysate circuit 32 may further include other components such as those described in U.S. patent application Ser. No. 11/148,928, entitled Dialysis System and filed on Jun. 9, 2005, which is hereby incorporated by reference in its entirety.

The blood circuit 28 includes another tube set including an arterial line 36 for withdrawing blood from the patient 11 and delivering it to the dialyzer 30, and a venous line 38 for returning the treated blood to the patient 11. A blood pump 40 drives the blood around the blood circuit 28. A valve 41 is situated on a gas line 42 for supplying negative and positive pressure from a source 43 to the pump 40. The arterial line 36 also incorporates a valve 45 that can stop the flow of blood from the patient 11, an ultrasound or other monitor 46 of the type available from Transonic to measure the concentration of saline in the blood, and a flow sensor 47 that measures the flow of blood. The arterial line 36 further includes a valve 48 upstream of the pump 40 and a valve 50 downstream on the pump 40. The blood pump 40 may be configured as described in U.S. patent application Ser. No. 10/399,128, entitled Device and Methods for Body Fluid Flow Control In Extracorporeal Fluid Treatments, filed on Jul. 28, 2003, which is hereby incorporated by reference in its entirety.

Other components which interact with the blood circuit 28 include a source of fluid, such as a saline bag 52, which communicates with the arterial line 36 via a branch line 54 and a valve 56 responsive to processor 14. Additionally, an anticoagulant solution such as a heparin supply 58 may communicate with the arterial line 36 through a branch line 60 and a pump 62 responsive to processor 14. A saline bolus may be administered to the blood stream by briefly closing clamp 45 opening clamp 56 and continuing operation of blood pump 40, thus drawing in saline rather than blood into the circuit. The clamps may then be returned to position for the pump to draw blood into the circuit and push the saline and blood through the dialyzer and return blood line 38. It is understood by persons skilled in the art that additional elements may be added to the blood circuit 36, such as air detectors in the branch lines 54 or 60. These additional elements are omitted from the drawings for clarity of illustration. Finally, the venous line 38, which delivers the treated blood from the dialyzer 30 to the patient 11, also includes a valve 64, an ultrasound monitor 66 of the type available from Transonic, and a flow sensor 68.

The processor 14 coordinates the operation of the dialysis system 10 by controlling the blood flow in the blood circuit 28, the dialysate flow in the dialysate circuit 32, and the flow of saline 52 or heparin 58 to the arterial line 36 via the branch lines 54 and 60, respectively. To achieve this, the processor 14 utilizes hardware and/or software configured for operation of these components and may comprise any suitable programmable logic controller or other control device, or combination of control devices, that is programmed or otherwise configured to perform as is known in the art. Thus, blood flow in the blood circuit 28 is controlled by operating the blood pump 40 and controlling the valves in the arterial and 36 and venous 38 lines. Dialysate flow in the dialysate circuit 32 is controlled by operating the dialysate pump 34. 100291 The processor 14 is also responsive to various input signals it receives, such as input signals from one or more flow sensors 47, 68, ultrasound monitors 46, 66, as will be described in greater detail below, and the clock/timer 26. Note that ultrasonic transit time monitors can serve both for measurement of flow and measurement of saline concentration within the blood. Thus, the function of sensors 46 and 47 may be provided by a single sensor and the function of sensors 64 and 68 may also be provided by a single sensor. Additionally, the processor 14 displays system status and various other treatment parameters, known in the art, on the display 20. That allows the operator to interact with the processor 14 via the data entry device 18 (which could include a touch sensitive display 20).

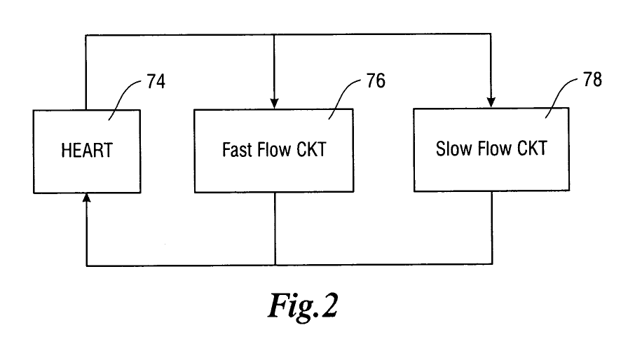

Turning now to FIG. 2, a model of the blood flow through the human body is illustrated. In FIG. 2, a heart 74 provides blood to two parallel circuits, a fast flow circuit 76 and a slow flow circuit 78. The fast flow circuit 76 is comprised of, for example, the kidneys, certain small organs, the heart, brain, gut and liver, and lungs. The slow flow circuit is comprised of the remaining organ systems, such as the muscles, bones, skin, and fat. During dialysis, if the flow through the gut is limited by constriction of blood vessels, then it can convert from a high flow to a low flow system. The reader should appreciate that the exact composition of the fast flow circuit 76 and slow flow circuit 78 is not critical to the present invention. There may be some dispute in the art as to which organs belong in which circuit. However, for purposes of this disclosure, it is only necessary to recognize that there is a fast flow circuit 76 and a slow flow circuit 78, without understanding the precise composition of each of those circuits.

Those of ordinary skill in the art will recognize that blood returns to the heart 74 through the fast flow circuit 76 quicker than blood will return to the heart from the slow flow circuit 78. Additionally, stress on the body which, for example, causes muscles to contract, will result in blood flowing through the slow flow circuit 78 to take even longer to return to the heart 74.

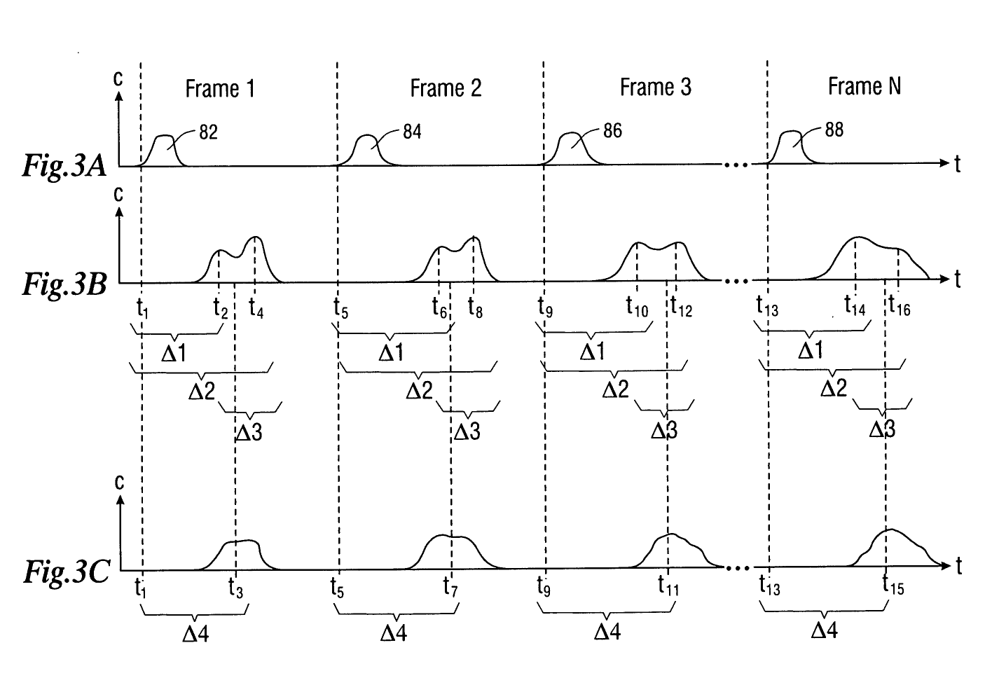

Turning now to FIG. 3, FIG. 3 is a timing diagram illustrating various measurements taken according to certain embodiments of the present invention. In FIG. 3, at time t1, a bolus 82 is injected via the venous line 38 into the patient 11 during dialysis. The time t1 may be saved as the injection time for the bolus 82. The reader should understand that the injection time for the injection of the bolus 82 need not be the beginning of the injection of the bolus 82 into the venous line. Any appropriate time during the injection of the bolus 82 may be used as the injection time so long as that time can be reliably reproduced during the injection of subsequent boluses. T1 can be the time of passage of the saline bolus past the ultrasound monitor 66 or other detector of saline on the outflow line of the dialysis machine.

Turning now to FIG. 3B, the concentration of return flows is measured as a function of time. In FIG. 3B, the return flows that are measured are the peak concentration which occurs at time t2 as a result of a return flow through the fast flow circuit 76 and a peak concentration which occurs at time t4 as a result of the return flow through the slow flow circuit 78. Although the times t2 and t4 at which the peaks occur are illustrated in FIG. 3B, other times at which other concentrations occur may be used, provided those concentrations can be reliably measured in response to the injection of subsequent boluses. From that data, various quantities may be calculated. A first quantity, Δ1, is the difference between the injection time of the bolus and the time t2 at which the peak occurs resulting from the return flow through the fast flow circuit 76. Another quantity, Δ2, is the difference between the injection time t1 and the time t4 at which the peak concentration resulting from the return flow through the slow flow circuit 78 occurs. Another quantity, Δ3, is the difference between the time t2 at which the first peak occurs and the time t4 at which the second peak occurs

Turning now to FIG. 3C, it is anticipated that in some patients the two peaks clearly visible in Frame 1 of FIG. 3B may not be distinguishable. That may be due to physiological differences amongst patients or because the measuring equipment used on certain dialysis machines may be incapable of differentiating small differences in values. In any event, in FIG. 3C, time t3 represents the receipt of a particular concentration of the return flow resulting from the injected bolus 82. The particular concentration may occur as the peak of the return flow, or may be some average value of concentration of the curve. However, whatever particular concentration is chosen, that concentration must be capable of being reliably sensed in response to the injection of subsequent boluses. In FIG. 3C, the quantity Δ4 is the difference between the injection time t1 of the bolus 82 and the time of receipt t3 of the particular concentration of the return flow.

Returning to FIG. 3A, it is seen at time t5 that another bolus 84 is injected. Subsequent boluses 86 and 88 are injected at times t9 and t13, respectively. Each of the boluses 82, 84, 86 and 88 defines a frame, i.e., frame 1, frame 2, frame 3, and frame N, respectively performed at consecutive times during a dialysis procedure. In each of the frames, as shown by FIG. 3B, values for Δ1, Δ2, and Δ3 are calculated. As shown in FIG. 3C, for each of the frames, a value for Δ4 is calculated. By comparing one or more of the values Δ1, Δ2, Δ3, and/or Δ4 from one frame, with its corresponding value in another frame, a determination of the patient's condition can be made. For example, by time t9, boluses 82 and 84 have been injected and values for one or more of Δ1, Δ2, Δ3, and/or Δ4 have been calculated for frame 1 and frame 2. Comparing the value of Δ1 in frame 1 with the value of Δ1 in frame 2, if the value is the same, the patient is considered to be stable. If the value of Δ1 has decreased from frame 1 to frame 2, the patient is considered to be approaching that patient's dry weight.

The value of Δ2 in frame 1 can also be compared to the value of Δ2 from frame 2. If the values of Δ2 from frame 1 and frame 2 are the same, the patient is considered to be stable. However, if the value of Δ2 from frame 2 is greater than the value of Δ2 from frame 1, the patient is considered to be approaching that patient's dry weight.

The value of Δ3 from frame 1 can be compared with the value for Δ3 from frame 2. If the two values are the same, the patient is considered to be stable. However, if the value of Δ3 increases from frame 1 to frame 2, the patient is considered to be approaching that patient's dry weight.

The value of Δ4 from frame 2 can be compared to the value of Δ4 for frame 1. If the value of Δ4 from frame 2 is the same as the value for Δ4 from frame 1, the patient is considered to be stable. However, if the value for Δ4 from frame 2 is smaller than the value of Δ4 for frame 1, the patient is considered to be approaching that patient's dry weight.

It is anticipated that a bolus may be injected approximately every five minutes during dialysis. Because dialysis normally takes hours, it can be appreciated that a substantial amount of data as well as a substantial number of values for the parameters Δ1, Δ2, Δ3, and/or Δ4 may be accumulated. It may be that the patient remains stable for several hours during dialysis, with the patient beginning to approach their dry weight after several hours of dialysis. It will be appreciated by those of ordinary skill in the art that the values for Δ1, Δ2, Δ3, and/or Δ4 accumulated for each of the frames may be compared amongst the frames so as to establish not only trends for this particular dialysis session, but historical trends for the patient over a plurality of dialysis sessions. Thus, an indication may be provided to the user, whether the user is a healthcare professional or the patient, of whether the patient is stable or approaching that patient's dry weight. By using the data within a dialysis session, dialysis may be controlled in a manner so as to maintain the patient safe throughout the dialysis process. When historical data is gathered for a patient, whether that historical data is from one or multiple dialysis sessions, the data may be used to determine that patient's dry weight.

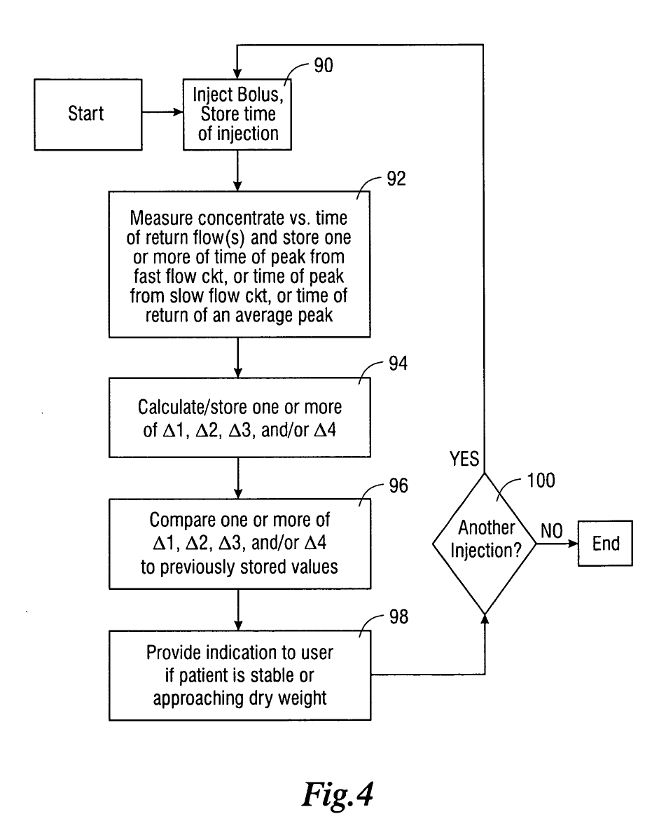

A flow chart illustrating the steps of various embodiments of the process of the present invention is disclosed in FIG. 4. The process begins at block 90 where a bolus is injected into a patient during dialysis. The time of injection of the bolus is stored. As previously stated, the time representing the injection of the bolus may be any appropriate time that can be reproduced during subsequent injections.

At block 92 the concentrations versus time of one of more return flows as a result of the injected bolus are measured. As discussed above in conjunction with FIG. 3B, there may be two peaks, one resulting from flow through a fast circuit path and a second resulting from flow through a slow circuit path. Alternatively, as shown in FIG. 3C, the peak which is stored may be an average of the two aforementioned peaks. Additionally, as discussed above, the point which is measured need not be the peak, so long as the point that is measured is reproducible from injection to injection. The concentration at the peak resulting from the return flow from the fast circuit path and the concentration at the peak from the return flow from the slow circuit path may be measured in addition to the previous measurements.

At block 94 one or more of the following quantities are calculated:

Δ1 which is the difference in time between the injection time and the receipt of a particular concentration from a return flow resulting from the flow through the fast circuit path;

Δ2 which is the difference in time between the injection time and the time of receipt of a particular concentration of a return flow resulting from the slow circuit path;

Δ3 which is the difference in time between the time of receipt of a particular concentration of a return flow resulting from the fast circuit path and the time of receipt of a particular concentration of a return flow resulting from the slow circuit path; and

Δ4 which is the difference in time between the injection time and the time of receipt of a particular concentration resulting from the injected bolus; and

At block 96, the various values of Δ1, Δ2, Δ3, and/or Δ4 are compared to their corresponding values from previous frames. Based on that comparison, an indication can be provided at 98 indicating whether the patient is stable or whether the patient is approaching their dry weight as discussed above in conjunction with FIG. 3.

At decision block 100, a determination is made if another injection is to be made. If yes, the process returns to block 90. If no, the process ends.

The present invention can be used with a variety of different commercially available dialysis machines; one such machine particularly suited for use with the present invention is a dialysis machine sold under the registered trademark ALLIENT by Renal Solutions, Inc., the assignee of the invention herein. The invention may also be used with any number of monitors which can detect the difference between saline and blood, essentially anything measuring physical differences between saline and blood. Examples include: transit time ultrasound sensors (as in the Transonic), Doppler ultrasound sensors, optical transmission sensors, optical reflectance sensors, magnetic sensors, conductivity sensors, temperature sensors, density sensors and so on. The invention may also be used with markers other than saline that have physical differences from blood, as long as there is an appropriate sensor for the concentration compound passing through a blood line. Examples include: dyes, radioactive substances, magnetic substances, fluids of high or low density, magnetic fluids, etc.

While the present invention has been described in conjunction with preferred embodiments thereof, those of ordinary skill in the art will recognize that many modifications and variations are possible. The present invention is therefore not intended to be limited by the foregoing description, but only by the following claims.

What is claimed is:

1. A method of controlling dialysis, comprising:
injecting a bolus into a blood stream during dialysis;
storing a time of injection of said bolus;
measuring a time of receipt of a return flow resulting from said injected bolus;
repeating said injecting, storing and measuring steps a plurality of times; and
determining a patient's condition from said plurality of stored times of injection and measured times.

2. The method of claim 1 wherein said measuring a time of receipt of a return flow corresponds to measuring one of a maximum concentration or an average concentration.

3. The method of claim 1 wherein said measuring a time of receipt comprises measuring a time of receipt of a return flow from a fast flow circuit through the human body.

4. The method of claim 3 wherein said determining a patient 's condition comprises determining a difference between said stored time of injection and said measured time of receipt, and comparing said difference from one injected bolus to a next injected bolus.

5. The method of claim 4 wherein said patient is considered to be stable if said difference from one injected bolus to the next is constant, and said patient is considered to be approaching the patient's dry weight if said difference from one injected bolus to the next is decreasing.

6. The method of claim 1 wherein said measuring a time of receipt comprises measuring a time of receipt of a particular concentration from a return flow from a slow flow circuit through the human body.

7. The method of claim 6 wherein said determining a patient 's condition comprises determining a difference between said stored time of injection and said measured time of receipt, and comparing said difference from one injected bolus to a next injected bolus.

8. The method of claim 7 wherein said patient is considered to be stable if said difference from one injected bolus to the next is constant, and said patient is considered to be approaching the patient's dry weight if said difference from one injected bolus to the next is increasing.

9. The method of claim 1 wherein said measuring a time of receipt comprises measuring a time of receipt of a particular concentration of an average return flow from a slow flow circuit and from a fast flow circuit through the human body.

10. The method of claim 9 wherein said determining a patient 's condition comprises determining a difference between said stored time of injection and said measured time of receipt, and comparing said difference from one injected bolus to a next injected bolus.

11. The method of claim 10 wherein said patient is considered to be stable if said difference from one injected bolus to the next is constant, and said patient is considered to be approaching the patient's dry weight if said difference from one injected bolus to the next is decreasing.

12. A method of controlling dialysis, comprising:
injecting a bolus into a blood stream during dialysis;
measuring a first time of receipt of a particular concentration of a first return flow resulting from said injected bolus;
measuring a second time of receipt of said particular concentration of a second return flow resulting from said injected bolus;
determining a time difference between said first and second times;
repeating said injecting, measuring a first time, measuring a second time, and determining a time difference a plurality of times; and
determining a patient's condition from said plurality of time differences.

13. The method of claim 12 wherein said particular concentration corresponds to a maximum concentration.

14. The method of claim 12 wherein said determining comprises comparing said time differences.

15. The method of claim 14 wherein said patient is considered to be stable if said difference from one injected bolus to a next is constant, and said patient is considered to be approaching the patient's dry weight if said difference from one injected bolus to a next is increasing.

16. A dialysis machine, comprising:
a first pump and a first plurality of valves for moving blood through a blood circuit;
a second pump for moving dialysate through a dialysate circuit; and
a control system comprising an input device for receiving information; a non-volatile memory device responsive to said input device for storing patient specific information; and a processor responsive to said memory device, said memory device carrying instructions which, when executed, cause the control system to execute a method comprising:
injecting a bolus into a blood stream during dialysis;
storing a time of injection of said bolus;
measuring a time of receipt of a particular concentration of a return flow resulting from said injected bolus;
repeating said injecting, storing and measuring steps a plurality of times; and
determining a patient's condition from said plurality of stored times of injection and measured times.

17. The machine of claim 16 wherein said measuring a time of receipt comprises measuring a time of receipt of a particular concentration from a return flow from a fast flow circuit through the human body.

18. The machine of claim 17 wherein said determining a patient 's condition comprises determining a difference between said stored time of injection and said measured time of receipt, and comparing said difference from one injected bolus to a next injected bolus.

19. The machine of claim 18 wherein said patient is considered to be stable if said difference from one injected bolus to the next is constant, and said patient is considered to be approaching the patient's dry weight if said difference from one injected bolus to the next is decreasing.

20. The machine of claim 16 wherein said measuring a time of receipt comprises measuring a time of receipt of a particular concentration from a return flow from a slow flow circuit through the human body.

21. The machine of claim 20 wherein said determining a patient 's condition comprises determining a difference between said stored time of injection and said measured time of receipt, and comparing said difference from one injected bolus to a next injected bolus.

22. The machine of claim 21 wherein said patient is considered to be stable if said difference from one injected bolus to the next is constant, and said patient is considered to be approaching the patient's dry weight if said difference from one injected bolus to the next is increasing.

23. The machine of claim 16 wherein said measuring a time of receipt comprises measuring a time of receipt of a particular concentration of an average return flow from a slow flow circuit and from a fast flow circuit through the human body.

24. The machine of claim 23 wherein said determining a patient 's condition comprises determining a difference between said stored time of injection and said measured time of receipt, and comparing said difference from one injected bolus to a next injected bolus.

25. The machine of claim 24 wherein said patient is considered to be stable if said difference from one injected bolus to the next is constant, and said patient is considered to be approaching the patient's dry weight if said difference from one injected bolus to the next is decreasing.

26. A computed readable storage medium carrying a set of instructions which, when executed, perform a method comprising:
injecting a bolus into a blood stream during dialysis;
storing a time of injection of said bolus;
measuring a time of receipt of a return flow resulting from said injected bolus;
repeating said injecting, storing and measuring steps a plurality of times; and
determining a patient's condition from said plurality of stored times of injection and measured times.
